(19) United States
(12) Patent Application Publication
(10) Pub. No.: US 2013/0065743 A1
(43) Pub. Date: Mar. 14, 2013

(54) METHODS AND APPARATUS FOR ENCLOSING A ROLLER SLEEVE

(71) Applicants: Ben D. Leonard, Toronto (CA); Vance A. Macdonald, Calgary (CA)

(72) Inventors: Ben D. Leonard, Toronto (CA); Vance A. Macdonald, Calgary (CA)

(73) Assignee: Kovrd Products Inc.

(21) Appl. No.: 13/608,926

(22) Filed: Sep. 10, 2012

Related U.S. Application Data
(60) Provisional application No. 61/532,309, filed on Sep. 8, 2011.

(51) Int. Cl. B25F 5/00

(52) U.S. Cl. 492/48

(57) ABSTRACT

Methods and apparatus for enclosing a roller sleeve according to various aspects of the present invention comprise a cylindrical body that is configured to receive a paint roller sleeve to reduce the rate at which paint on the sleeve dehydrates. The cylindrical body may comprise a selectively attachable end piece that allows for an arm member of a paint roller frame to be coupled to and/or decoupled from the paint roller sleeve when the sleeve is positioned within the cylindrical body.

### CROSS-REFERENCES TO RELATED APPLICATIONS

This application claims the benefit of U.S. Provisional Patent Application No. 61/532,309, filed Sep. 8, 2011, and incorporates the disclosure of the application by reference.

### BACKGROUND OF INVENTION

Paint and paint application devices are subject to oxidation, dehydration, and contaminants when being used or stored. To avoid dehydration after use, paint is often stored in an air tight container and paint application devices are cleaned when not in use. During a painting process, there are often instances when the painting process is temporarily interrupted or halted for minutes or hours at a time. During these times it is necessary to protect the unused paint from drying out. A common method is to return the unused paint to its air tight container and clean the application device. Depending on a given situation, cleaning the paint application device may be time consuming and wasteful.

### SUMMARY OF THE INVENTION

Methods and apparatus for enclosing a roller sleeve according to various aspects of the present invention comprise a cylindrical body that is configured to receive a paint roller sleeve to reduce the rate at which paint on the sleeve dehydrates. The cylindrical body may comprise a selectively attachable end piece that allows for an arm member of a paint roller frame to be coupled to and/or decoupled from the paint miler sleeve when the sleeve is positioned within the cylindrical body.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 representatively illustrates a body portion of a roller sleeve tube in accordance with an exemplary embodiment of the present invention;

FIG. 2 representatively illustrates the insertion of a roller sleeve into the body portion of the roller sleeve tube;

FIG. 3 representatively illustrates the roller sleeve tube and an end piece;

FIG. 4A representatively illustrates a side view of the end piece;

FIG. 4B representatively illustrates a cross-sectional view of the end piece;

FIG. 4C representatively illustrates art uncoupled collar and plug portion of the end piece in accordance with an exemplary embodiment of the present invention;

FIG. 5A representatively illustrates a top view of the roller sleeve tube with recessed finger grooves;

FIG. 5B representatively illustrates a back view of the roller sleeve tube with recessed finger grooves;

FIG. 5C representatively illustrates a side view of the roller sleeve tube with recessed finger grooves;

FIG. 6A representatively illustrates the roller sleeve tube with internal threads;

FIG. 6B representatively illustrates the roller sleeve tube with external threads;

FIG. 7 representatively illustrates a cross-section of the roller sleeve tube with an interior securing element; and

FIG. 8 representatively illustrates a flowchart showing removal of the paint roller pad from the paint roller device.

### DETAILED DESCRIPTION OF EXEMPLARY EMBODIMENTS

The present invention may be described in terms of functional block components and various processing steps. Such functional blocks may be realized by any number of components configured to perform the specified functions and achieve the various results. For example, the present invention may employ various types of covers, seals, storage equipment for various types of painting materials and the like, which may carry out a variety of functions. In addition, the present invention may be practiced in conjunction with any number of processes such as removal and replacement of a roller sleeve from a paint roller frame, the protection and storage of paint supplies, and improving ease of clean up, and the system described is merely one exemplary application for the invention. Further, the present invention may employ any number of conventional techniques for preventing materials from drying out, reducing exposure to circulating air, providing protection against damage, and/or sealing enclosed spaces.

Methods and apparatus for enclosing a roller sleeve according to various aspects of the present invention may operate in conjunction with any suitable paint application system and/or paint material. Various representative implementations of the present invention may be applied to any system for removing and storing paint applicator devices.

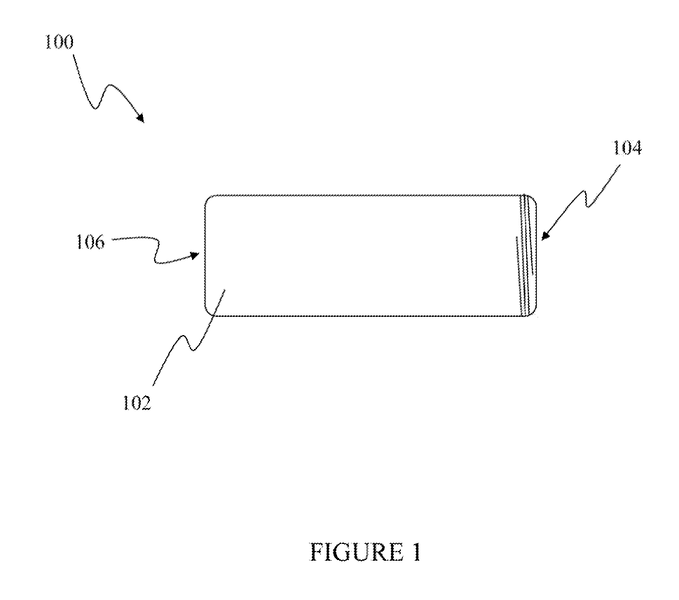

Referring now to FIG. 1, in an exemplary embodiment of the present invention a roller sleeve tube 100 may be adapted to receive a roller sleeve. The roller sleeve tube 100 may comprise any suitable device for receiving an object such as a tube, a cylinder, a box, and the like. The roller sleeve tube 100 may also comprise any suitable cross-sectional dimension, such as circular, square, rectangular, or elliptical. For example, the roller sleeve tube 100 may comprise a cylindrical body 102 of a predetermined, length having an open end 104, a sealed end 106, and an interior receiving section of sufficient diameter to receive a paint roller sleeve as is commonly known in the art. The interior diameter of the roller sleeve tube 100 may comprise any suitable size from about one inch in diameter to about 6 inches in diameter.

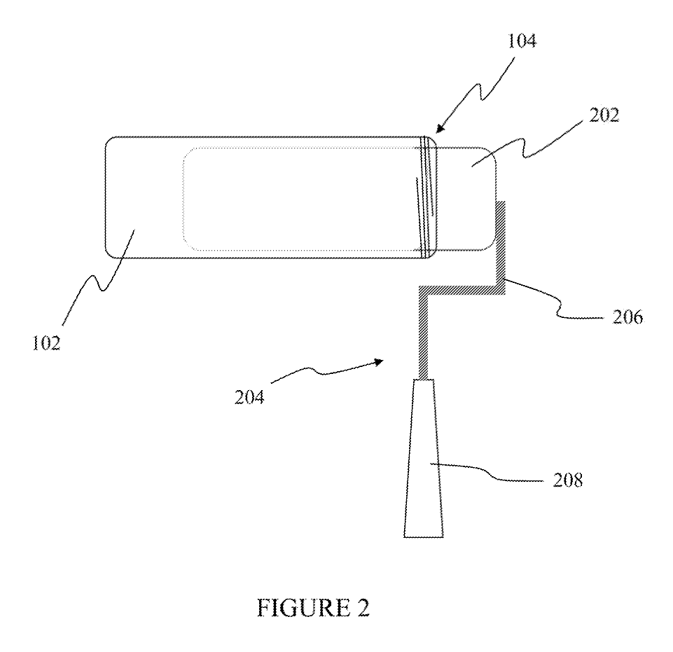

In one embodiment the interior diameter of the cylindrical body 402 may be approximately one and a half inches. In another embodiment the interior diameter of the cylindrical body 102 may be approximately three and a half inches. The cylindrical body 102 may also be configured in any suitable length. For example, the cylindrical body 102 may comprise a length of anywhere between three and twenty inches. Referring now to FIG. 2, the overall length and interior diameter of the cylindrical body 102 may allow the cylindrical body 102 to slide over and substantially enclose a roller sleeve 202 that is attached to a roller frame 204 and inserted into the receiving section of the cylindrical body 102 through the open end 104.

The cylindrical body 102 may comprise any suitable material such as plastic, rubber, metal, cardboard, or the like. Further, the cylindrical body 102 may be formed by any suitable method such as by extrusion, molding, or assembled from multiple sections. For example, in one embodiment, the cylindrical body 102 may comprise a polyvinyl chloride or similar thermoplastic polymer molded to form an enclosure having an open end.

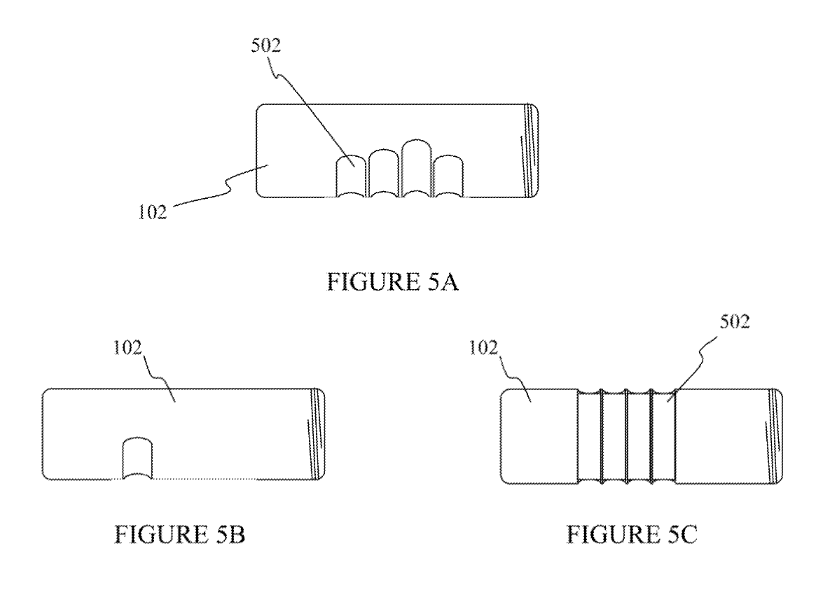

The cylindrical body 102 may also comprise an element suitably adapted to facilitate easy gripping, and/or use. For example, referring now to FIG. 5A-5C, in one representative embodiment, an exterior surface of the cylindrical body 102 may comprise one or more recessed portions 502, or grooves adapted to conform to fingers. In another embodiment, the exterior surface of the cylindrical body 102 may comprise a non-slip material or coating. In yet another embodiment, the cylindrical body 102 may comprise a handle positioned opposite the open end of the cylindrical body 102.

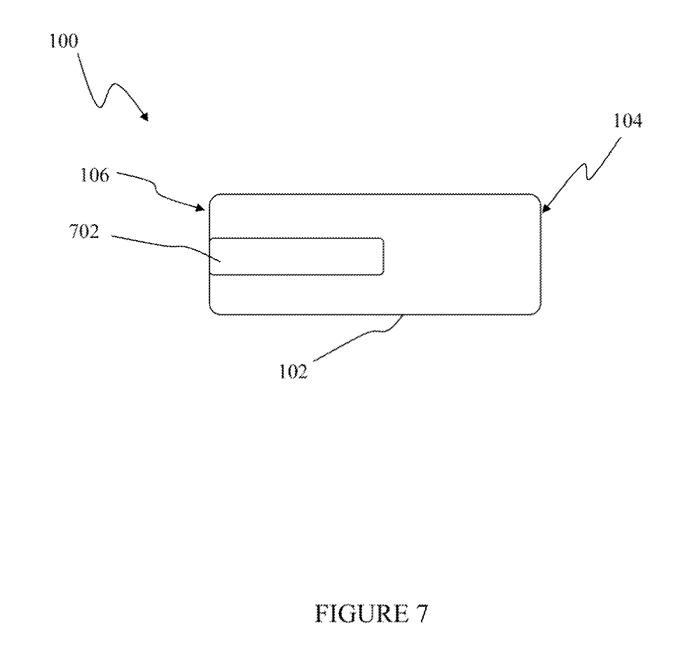

Referring now to FIG. 7, the cylindrical body 102 may further comprise an interior element for securing and/or stabilizing the roller sleeve 202 to the interior of the cylindrical body 102, such as a guide, one or more interior ridges, and a post. In one embodiment, the interior of the cylindrical body 102 may comprise a cylindrical protrusion 702 extending from the sealed end 106 towards the open end 104, wherein the cylindrical protrusion 702 may comprise a diameter of anywhere between about one-sixteenth of an inch and about five inches. The diameter of the cylindrical protrusion may be configured to be slightly less than an interior diameter of the roller sleeve 202. For example, in one embodiment, the diameter of the protrusion 702 may be on the order of 5/16 of an inch so that it may slide into a standard ⅜ inch diameter roller sleeve 202 without excessive force. The protrusion 302 may be of any suitable length to sufficiently secure the roller sleeve 202. For example, the protrusion 702 may span the entire length of the interior of the cylindrical body 102 or it may span some fraction less than the length of the cylindrical body 102.

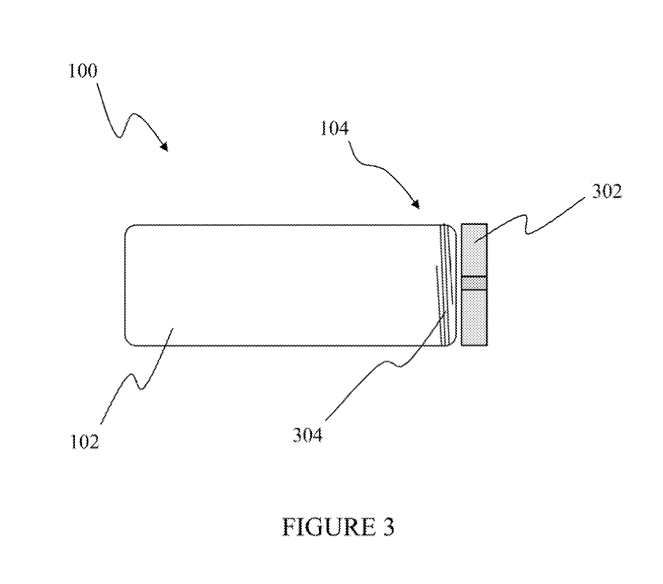

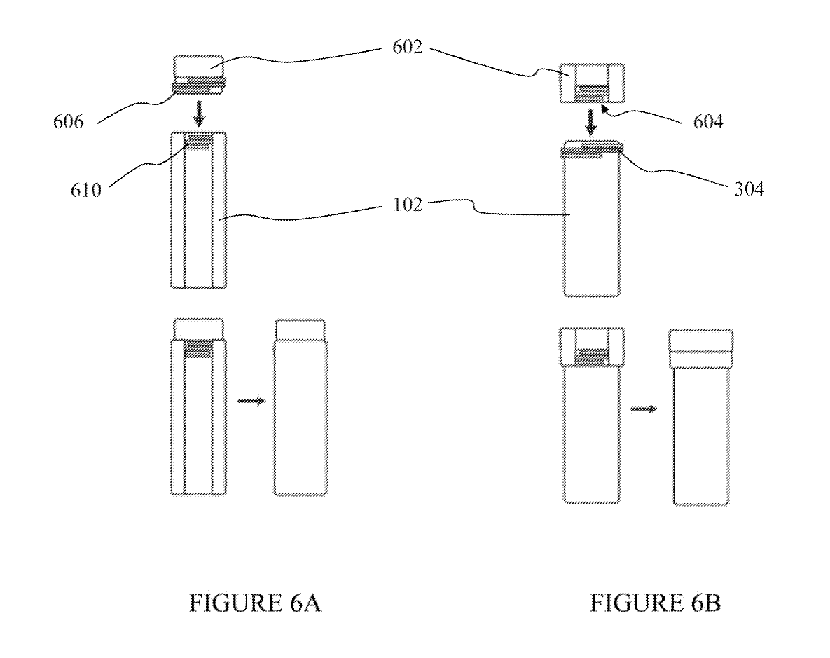

Referring now to FIGS. 3, 6A, and 68, the roller sleeve tube 100 may comprise an end piece 302 suitably configured to couple to the open end 104 of the cylindrical body 102 and seal off the interior receiving section of the cylindrical body 102. The end piece 302 may comprise any suitable device for sealing off the open end 104 of the cylindrical body 102 such as a cap, a plug, a lid, and the like. The end piece 302 may be configured to provide any type of seal desired such as an airtight and/or watertight seal. For example, the end piece 302 may comprise, a gasket that is configured to engage a portion of the cylindrical body 102 to provide a seal between the interior receiving section of the cylindrical body 102 and the ambient environment. In an alternative embodiment, the end piece 302 may be configured to provide a semi-impervious seal between the interior of the cylindrical body and the ambient environment sufficient to prevent the roller sleeve 202 from drying out over a period of about 24-72 hours.

The end piece 302 may also couple to the open end 104 of the cylindrical body 102 by any suitable method. For example, the end piece 302 may comprise a cap 602 having an interior threaded portion 604 that is suitably adapted to mate to a threaded exterior portion 304 of the cylindrical body 102. Alternatively, the cap 602 ma comprise an exterior threaded portion 606 that is suitably adapted to mate with a threaded interior portion 608 of the cylindrical body 102. In another embodiment, the end piece 302 may couple to the interior or exterior of the cylindrical body 102 via a compression fit or a snapping mechanism. In yet another embodiment, the cylindrical body 102 and the end piece 302 may be adapted to couple together via a channeled groove disposed on one element and a protrusion disposed on the other element, wherein the protrusion is suitably adapted to fit into and slide along the groove.

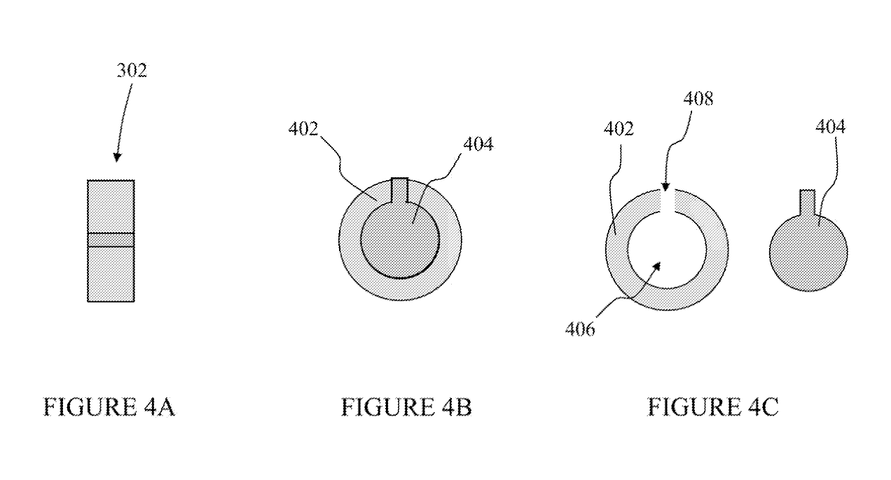

The end piece 302 may be suitably adapted to connect to the open end 104 of the cylindrical body 102 while the roller sleeve 202 is still attached to the roller frame 204. The end piece 302 may be configured in any suitable way to facilitate connection to the open end 104 of the cylindrical body 102 while allowing the roller sleeve 202 to be coupled to or decoupled from the roller frame 204 after the cylindrical body 102 and end piece 302 have been coupled together. For example, referring now to FIGS. 4A. 4B and 4C, in one representative embodiment, the end piece 302 may comprise a collar 402 suitably adapted to account for structural elements of the roller frame 204 and a plug 404 adapted to couple to the collar 402.

The collar 402 may be suitably configured to couple to the cylindrical body 102 without being impeded by the roller frame 204 if it is still connected to the roller sleeve 202. For example, in one embodiment, the collar 402 may comprise an open center portion 406 and a first mating section 408 suitably adapted to fit around at least a portion of the roller frame 204, such as an arm member 206 extending between a handle 208 and a rotating roller body portion (not shown) of the roller frame 204 that fits into the roller sleeve 202. After the roller sleeve 102 has been inserted into the receiving section, the collar 402 may be fit over the arm member 206 and coupled to the cylindrical body 102 thereby at least partially closing off the open end 104.

The open center portion 406 ma comprise a dimension adapted to fit around the rotating roller body portion of the roller frame 204 such that the roller sleeve 202 may be removed from the roller frame 204 while positioned within the receiving section of the cylindrical body 102 by pulling the roller frame 204 away from the cylindrical body 102 when the collar 402 is coupled to the cylindrical body 102. The open center portion 406 may have any suitable radius of between about one-sixteenth of an inch and five inches depending at least in part on the size of the cylindrical body 102 and/or the size of the roller sleeve 202. The collar 402 may also comprise any suitable material such as plastic, metal, or rubber.

The plug 404 is adapted to couple to the collar 402 and fill in the open center portion 406 and the first mating section 408 of the collar 402 to seal off the interior of the cylindrical body 102. The plug 404 may comprise any suitable element or device for filling in the open portions of the collar 402. For example, in one embodiment, the plug 404 may comprise a plastic insert suitably adapted to slidably fit within the open center portion 406 and the first mating section 408 of the collar 402. The plug 404 may be configured in any suitable way to provide a secure connection between the collar 402 and the plug 404. For example, in one embodiment, the plug 404 may comprise a second mating section and have dimensions that are substantially the same as those of the open center portion 406 and the first mating section 408 of the collar 402. The plug 404 may also comprise a notch, tab, or handle shown) suitably adapted to allow the plug 404 to be selectively removed from the collar 402 without having to disconnect the collar 402 from the cylindrical body 102.

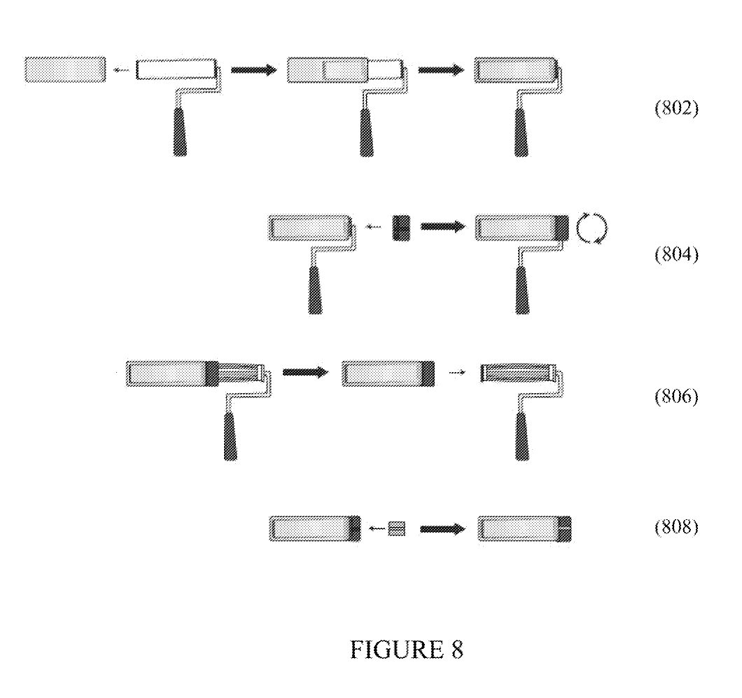

Referring now to FIG. 8, in operation, the open end 104 of the roller sleeve tube 100 may be slid over the roller sleeve 202 while coupled to the roller frame 204 to substantially enclose the roller sleeve 202 (802). Once the roller sleeve tube 100 is placed around the roller sleeve 202, the collar 402 may be coupled to the cylindrical body 102 of the roller sleeve tube 100 (804). For example, the collar 402 may slide over and around an arm portion of the roller frame 204 before being coupled to the cylindrical body 102. The roller sleeve tube 100 may then be pulled away from the roller frame 204 causing the roller sleeve 202 to be removed from the roller frame 204 (806), The plug 404 may then be inserted into an open portion of the collar 402 thereby sealing off the roller sleeve 202 into the interior receiving section of the roller sleeve tube 100 (808). The roller sleeve 202 may then be reattached to the roller frame 204 by performing the process in reverse or by removing the collar 402 and inserting the roller frame 204 into the roller sleeve 202.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise”, “comprises”, “comprising”, “having”, “including” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present invention, in addition to those not specifically recited, may be varied or otherwise particularly adapted to specific environments, manufacturing specifications, design parameters or other operating requirements without departing from the general principles of the same.

1. A cover for a paint roller sleeve, comprising:
a substantially tubular body comprising:
an open end;
a closed end; and
a receiving space between the open and closed ends;
a collar configured to selectively couple to the open end, wherein the collar comprises an open center portion; and
a plug configured to selectively couple to the open center portion of the collar, wherein the plug seals off the retaining space when the collar is coupled to the open end.

2. A cover according to claim 1, wherein the plug comprises a shape conforming to the open center portion of the collar.

3. A cover according to claim 1, wherein:
the collar further comprises a first mating section in a portion of the collar; and
the plug further comprises a second mating section configured to mate with the first mating section when the plug couples to the collar.

4. A cover according to claim 1, wherein:
the tubular body further comprises a set of threads along a surface of the open end; and
the collar further comprises a second set of threads configured to allow the collar to totally couple to the tubular body.

5. A cover according to claim 1, wherein the tubular body comprises a cylinder.

6. A cover according to claim 1, wherein the tubular body further comprises a recessed portion disposed on an exterior surface of the tubular body.

7. A rover according to claim 1, wherein the collar further comprises a sealing element configured to engage the tubular body and form a seal between the receiving space and an ambient environment surrounding the cover when the collar is coupled to the tubular body.
